(19) United States
(12) Patent Application Publication
(10) Pub. No.: US 2012/0012777 A1
(43) Pub. Date: Jan. 19, 2012

(54) POWDER FOR DUST CORE, DUST CORE MADE OF THE POWDER FOR DUST CORE BY POWDER COMPACTION, AND METHOD OF PRODUCING THE POWDER FOR DUT CORE

(75) Inventors: Masaki Sugiyama, Miyoshi-shi (JP); Toshiya Yamaguchi, Miyoshi-shi (JP); Shota Ohira, Toyota-shi (JP); Takeshi Hattori, Aichi-gun (JP); Yusuke Oishi, Nagoya-shi (JP)

(73) Assignee: TOYOTA JIDOSHA KABUSHIKI KAISHA, Toyota-shi (JP)

(21) Appl. No.: 13/258,753

(22) PCT Filed: Sep. 21, 2010
(86) PCT No.: PCT/JP2010/066752

§ 371 Date: Sep. 22, 2011

(30) Foreign Application Priority Data
Jan. 15, 2010 (JP) 2010-007438

(51) Int. Cl. H01F 1/26; H01F 41/02; H01F 1/22

(52) U.S. Cl. 252/62.54; 252/62.55; 427/127

(57) ABSTRACT

A powder for dust core including a soft magnetic metal powder and a silicon impregnated layer made of silicon concentrated in a surface layer of the soft magnetic metal powder, in which a silicon dioxide powder is diffusion-bonded to a surface of the silicon impregnated layer to form a diffusion-bonded part while a part of the silicon dioxide powder is impregnated and diffused in the silicon impregnated layer and the other part of the same protrudes from the surface of the silicon impregnated layer. The diffusion-bonded part creates a gap with respect to another powder for dust core, thereby providing increased specific resistance.

### TECHNICAL FIELD

The present invention relates to a powder for dust core, formed with a silicon impregnated layer of concentrated silicon in a surface layer of a soft magnetic metal powder, a dust core made of the powder for dust core by powder compaction, and a method of producing the powder for dust core.

### BACKGROUND ART

A dust core is produced by pressing powder for dust core constituted of soft magnetic metal powder. The dust core has many advantages such that it has magnetic characteristics that high-frequency loss (hereinafter, referred to as “iron loss”) occurring according to frequencies is lower than that of a core component formed of laminated magnetic steel plates; it can be adapted to various shapes according to circumstances and at low cost; and its material cost is low. Such dust core is applied to for example a stator core and a rotor core of a vehicle driving motor, a reactor core constituting an electric power converting circuit, and others.

For instance, a powder (particle) 101 for dust core in a first conventional art shown in FIG. 24 is configured such that silica fine powder (particles) 103 is dispersed and bonded on an iron powder (particle) 102 and a silicone resin layer 104 is formed to cover the surface of the fine powder 103 (e.g., see Patent Literature 1).

In such dust core powder 101, the silica fine powder 103 merely physically adheres to the surface of the iron powder 102 and thus only a low bonding force is provided between the silica fine powder 103 and the iron powder 102. Accordingly, if the dust core powder 101 rubs against another dust core powder 101 during powder compaction, the silica fine powder 103 sometimes rubs off from the surface of the iron powder 102 together with the silicone resin layer 104. In this case, the surfaces of the iron powder particles 102 directly contact with one another, resulting in a decreased volume-ratio resistance value (hereinafter, referred to as a “specific resistance”) of a dust core and hence an increased iron loss (mainly eddy current loss and hysteresis loss).

Therefore, a powder (particle) 201 for dust core shown in FIG. 25 is configured such that a silicon dioxide powder is impregnated and diffused from the surface of an iron powder (particle) 202 in a siliconizing (silicon impregnation) treatment, thereby forming a silicon impregnated layer 203 made by concentration of silicon element in the surface of the iron powder 202. In such dust core powder 201, the silicon impregnated layer 203 is unlikely to come off from the surface of the iron powder 202 even when the dust core powder 201 rubs against another dust core powder 201 during powder compaction. This dust core powder 201 can have a larger specific resistance than the dust core powder 101 shown in FIG. 24 and hence a smaller iron loss (see Patent Literatures 2 and 3).

Herein, the dust core powder 201 has higher hardness as the silicon impregnated layer 203 is thicker. This hard dust core powder 201 is unlikely to be deformed during powder compaction as shown in FIG. 26. Thus, large gaps S11 are generated between powder particles, resulting in a decreased density of a dust core. The silicon impregnated layer 203 is therefore designed to be have a thickness of 0.15 times or less of the particle diameter D of the iron powder 202 (e.g., see Patent Literature 2).

When the silicon impregnated layer 203 is thinner, if the dust core powder 201 is deformed during powder compaction and the thickness of the silicon impregnated layer 203 becomes irregular, the adjacent dust core powder particles 201 may contact with each other at respective thin portions of the silicon impregnated layers 203 as indicated by P11 in FIG. 27. Such portions have lower insulation property, leading to lower specific resistance of the dust core.

Therefore, a powder (particle) 301 for dust core shown in FIG. 28 is configured such that a layer 302 containing silicon dioxide is formed on the surface of the silicon impregnated layer 203 by oxidizing only the silicon impregnated layer 203 in a gradual oxidation treatment without oxidizing the iron powder 202. Even if the thickness of the silicon impregnated layer 203 becomes irregular during powder compaction, the layers 302 containing silicon dioxide are present between the powder particles and therefore such dust core powder 301 can more reduce the specific resistance occurring in the dust core than the dust core made of the dust core powder 201 shown in FIG. 25 (e.g., see Patent Literature 3).

### CITATION LIST

### Patent Literature

Patent Literature 1: JP-A-2008-169439
Patent Literature 2: JP-A-2009-256750
Patent Literature 3: JP-A-2009-123 774

### SUMMARY OF INVENTION

### Technical Problem

However, the dust core powder 301 shown in FIG. 28 is formed of the silicon-dioxide containing layer 302 to surround the silicon impregnated layer 203 by oxidizing the surface of the silicon impregnated layer 203. Specifically, the dust core powder 301 is formed with the silicon-dioxide containing layer 302 by oxidizing the surface of the silicon impregnated layer 203 formed with a thickness corresponding to 0.15 times of the particle diameter D of the iron powder 202. The thickness of the silicon-dioxide containing layer 302 is determined in a range from 1 nm to 100 nm in order to keep the density of the iron powder 202 during powder compaction and also ensure high insulation property. The thus thin layer 302 containing silicon dioxide is liable to be stretched under the pressure applied during powder compaction. Accordingly, the layer 302 becomes thinner and is broken. As indicated by P12 in FIG. 29, if the silicon-dioxide containing layers 302 of the adjacent dust core powder particles 301 are thin or broken at portions having thin silicon impregnated layers 203, gaps S12 created between the silicon impregnated layers 203 of the adjacent powder particles 301 are narrowed or the silicon impregnated layers 203 directly contact with each other, resulting in decreased insulation property. In this case, the specific resistance of the dust core decreases and thus iron loss increases.

In recent years, the dust core to be used in for example a vehicle inverter is used under a wide frequency range to continuously change the speed. Iron loss occurs according to the frequency. Therefore reduction in iron loss at high frequencies, that is, improvement of specific resistance is highly demanded by industrial users.

The present invention has been made to solve the above problems and has a purpose to provide a powder for dust core with high-specific resistance, a dust core made of the powder for dust core by powder compaction, and a method of producing the powder for dust core.

### Solution to Problem

To achieve the above purpose, one aspect of the invention provides a powder for dust core, the powder including a soft magnetic metal powder and a silicon impregnated layer made of silicon concentrated in a surface layer of the soft magnetic metal powder, wherein the silicon impregnated layer includes a silicon dioxide powder diffused and bonded to a surface of the silicon impregnated layer so that a part of the silicon dioxide powder is impregnated and diffused in the silicon impregnated layer and the other part of the silicon dioxide powder protrudes from the surface of the silicon impregnated layer.

Preferably, in the above powder for dust core, the silicon dioxide powder is diffused and bonded to the silicon impregnated layer during a siliconizing treatment for forming the silicon impregnated layer.

Preferably, in the above powder for dust core, the powder for dust core is coated with silicone resin.

Another aspect of the invention provides a dust core made of one of the powders for dust core mentioned above by powder compaction.

Furthermore, another aspect of the invention provides a method of producing a powder for dust core, the method comprising at least a step of performing a siliconizing treatment including: bringing a powder for siliconizing containing at least a silicon compound into contact with a surface of a soft magnetic metal powder, heating the powder for siliconizing to release a silicon element from the silicon compound, and impregnating and diffusing the released silicon element into a surface layer of the soft magnetic metal powder to form a silicon impregnated layer made of silicon concentrated in the surface layer of the soft magnetic metal powder, wherein the siliconizing treatment includes setting a heating time for heating the powder for siliconizing so that the powder for siliconizing is diffusion-bonded to a surface of the silicon impregnated layer while a part of the powder for siliconizing is impregnated and diffused in the silicon impregnated layer and the other part of the powder for siliconizing protrudes from the surface of the silicon impregnated layer.

Preferably, the above method further comprises a coating treatment for coating an outer surface of each powder with silicone resin after the powder is subjected to the siliconizing treatment.

Preferably, in the above method, the powder for siliconizing is a silicon dioxide powder, and the heating time is set at 45 minutes or less when the silicon dioxide powder has a mean particle diameter of 1 μm or less.

Another aspect of the invention provides a dust core made of the powder for dust core by powder compaction, the powder for dust core being produced by one of the aforementioned production methods of a powder for dust core.

### Advantageous Effects of Invention

According to the aforementioned powder for dust core, dust core made of the powder for dust core by powder compaction, and production method of the powder for dust core, even when the powder for dust core is deformed during powder compaction, increasing the density of the dust core, the silicon dioxide diffusion-bonded in the silicon impregnated layer firmly adheres to the silicon dioxide layer. Accordingly, even if the thickness of the silicon impregnated layer becomes uneven due to deformation, the powder for dust core having the protruding portions of the silicon dioxide powder from the silicon impregnated layer creates a gap from another powder particle for dust core, so that the powder particles are insulated from each other. According to the aforementioned powder for dust core, dust core made of the powder for dust core by powder compaction, and production method of the powder for dust core, therefore, the specific resistance can be more enhanced as compared with the case where a silicon dioxide containing layer is formed to coat the powder for dust core by oxidizing the surface of the silicon impregnated layer in the gradual oxidation treatment and others.

According to the aforementioned powder for dust core, dust core made of the powder for dust core by powder compaction, and production method of the powder for dust core, the silicon dioxide powder is diffusion-bonded to the silicon impregnated layer during the siliconizing treatment for forming the silicon impregnated layer. Thus, there is no need to separately conduct the gradual oxidation treatment and the siliconizing treatment to form the silicon dioxide containing layer by oxidizing the silicon impregnated layer.

According to the aforementioned powder for dust core, dust core made of the powder for dust core by powder compaction, and production method of the powder for dust core, the outer surface of the powder is coated with silicone resin and therefore a high insulation property is achieved between powder particles for dust core.

### BRIEF DESCRIPTION OF DRAWINGS

FIG. 1 is a conceptual diagram of a cross section of a powder for dust core in an embodiment of the invention;

FIG. 2 is a conceptual diagram to explain a state where a silicon dioxide powder is diffusion-bonded to a silicon impregnated layer;

FIG. 3 is a conceptual diagram to explain a production method of the dust core powder and show a cross section of an iron-carbon alloy powder before a siliconizing penetration treatment;

FIG. 4 is a conceptual diagram to explain the production method of the dust core powder and show a state where the iron-carbon alloy powder and a silicon dioxide powder are agitated;

FIG. 5 is an enlarged view of a part B in FIG. 4;

FIG. 6 is a diagram to explain the production method of the dust core powder and show a state during the siliconizing treatment;

FIG. 7 is a conceptual diagram to show a particle configuration of a dust core made of the dust core powder by powder compaction;

FIG. 8 is a conceptual diagram to explain a boundary portion of the dust core powder constituting the dust core;

FIG. 9 is a micrograph of powder subjected to the siliconizing treatment;

FIG. 10 is a diagram illustrating the micrograph of FIG. 9;

FIG. 11 is an enlarged micrograph of a part of FIG. 9 corresponding to P1 in FIG. 10;

FIG. 12 is a diagram illustrating the micrograph of FIG. 11;

FIG. 13 is an enlarged micrograph of a part of FIG. 11 corresponding to P2 in FIG. 12;

FIG. 14 is a diagram illustrating a micrograph of FIG. 13;

FIG. 15 is an enlarged micrograph of a part of FIG. 13 corresponding to P3 in FIG. 14;

FIG. 16 is a diagram illustrating the micrograph of FIG. 15;

FIG. 17 is a perspective external view of a ring member which is an example of the dust core;

FIG. 18 is a graph showing a relationship between heat treatment time and specific resistance in the siliconizing treatment step for dust core powder;

FIG. 19 is a conceptual diagram of a cross section of a dust core powder used in Example 1;

FIG. 20 is a conceptual diagram of a cross section of a dust core powder used in Example 3;

FIG. 21 is a conceptual diagram of a cross section of a dust core powder used in Example 4;

FIG. 22 is a table showing Comparative example and Example 2 to compare respective configurations;

FIG. 23 is a graph to compare specific resistance between Comparative example and Example 2;

FIG. 24 is a cross section of a dust core powder in a first conventional art;

FIG. 25 is a cross section of a dust core powder in a second conventional art;

FIG. 26 is a diagram showing a state of the dust core powder in the second conventional art after pressed and formed;

FIG. 27 is an enlarged conceptual diagram showing a boundary portion of the dust core powder shown in FIG. 26;

FIG. 28 is a cross section of a dust core powder in a third conventional art; and

FIG. 29 is an enlarged conceptual diagram showing a boundary portion of the dust core powder shown in FIG. 28.

### DESCRIPTION OF EMBODIMENTS

A detailed description of a preferred embodiment of a powder for dust core, a dust core made of the powder for dust core by powder compaction, and a production method of the powder for dust core embodying the present invention will now be given referring to the accompanying drawings.

<Configuration of Powder for Dust Core>

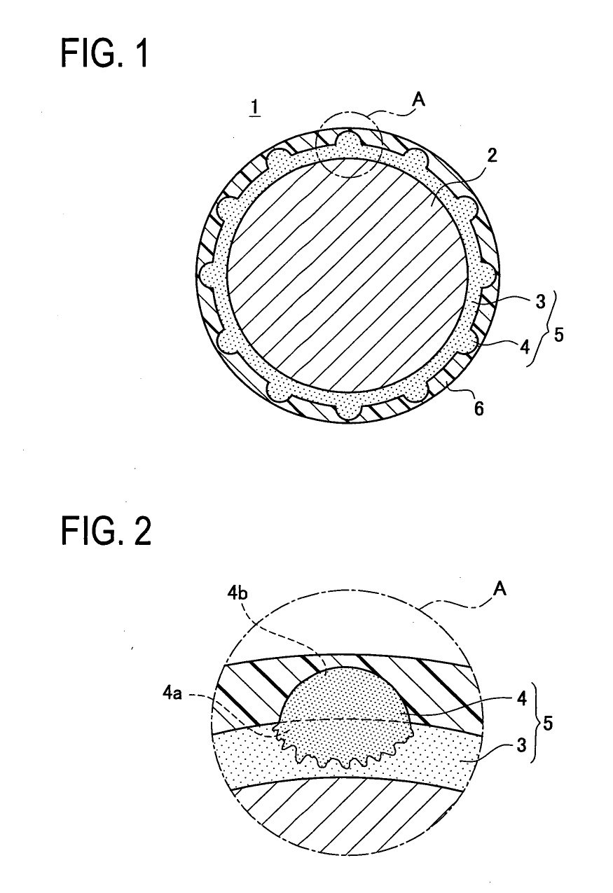

FIG. 1 is a conceptual diagram of a cross section of a powder (particle) 1 for dust core in this embodiment. FIG. 2 is a conceptual diagram to explain a state where a silicon dioxide powder (particle) 8 is diffusion-bonded to a silicon impregnated layer 3.

As shown in FIG. 1, the powder 1 for dust core (“dust core powder”) includes a silicon dioxide diffusion-bonded layer 5 and a silicone coating layer 6 covering an iron powder 2 (one example of a soft magnetic metal powder). The silicon dioxide diffusion-bonded layer 5 includes a silicon impregnated layer 3 made of a silicon element concentrated in a surface layer of the iron powder 2 and a diffusion-bonded part 4 made of the silicon dioxide powder 8 diffusion-bonded to the silicon impregnated layer 3. As shown in FIG. 2, the diffusion-bonded part 4 includes a diffused portion 4a made of a part of the silicon dioxide powder particle 8 being impregnated and diffused into the silicon impregnated layer 3 and a protruding portion 4b made of the other part of the silicon dioxide powder particle 8 protruding from the surface of the silicon impregnated layer 3. As shown in FIG. 1, the silicone coating layer 6 is made of silicone resin coating the silicon dioxide diffusion-bonded layer 5 to enhance insulation property thereof.

<Production Method of Powder For Dust Core>

A production method of the dust core powder 1 is explained below.

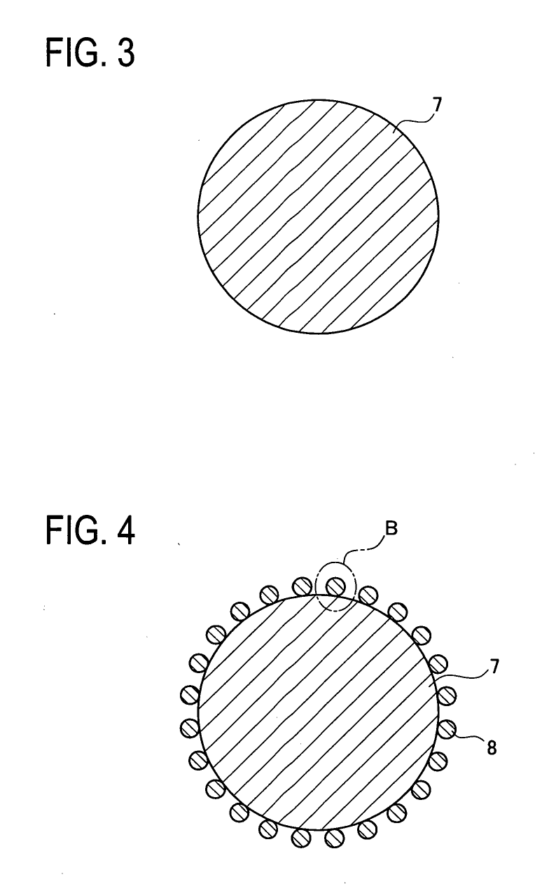

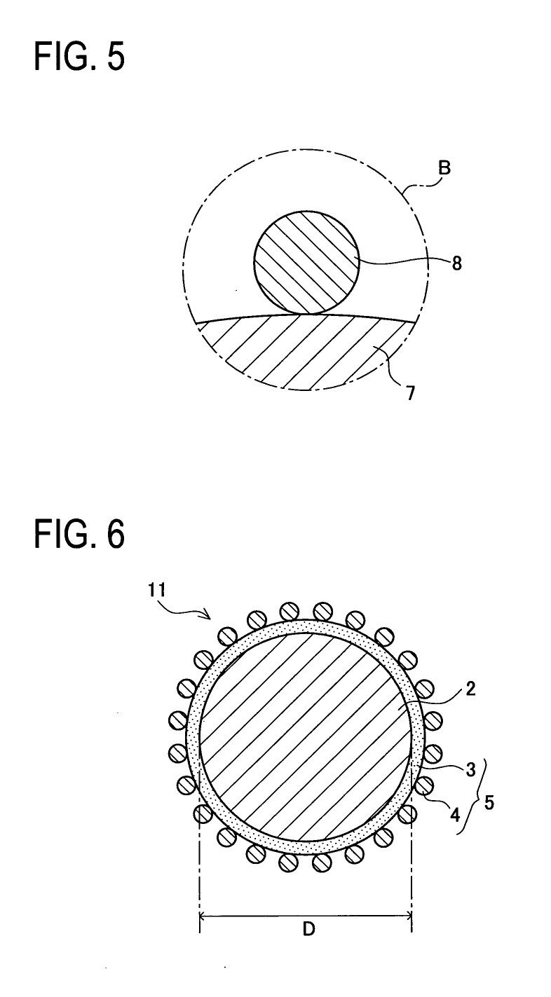

An agitating treatment is first conducted by adding and mixing the silicon dioxide powder 8 to an iron-carbon alloy powder 7 shown in FIG. 3 and then agitating them so that the silicon dioxide powder 8 adheres to the outer surface of each iron-carbon alloy powder particle 7. The silicon dioxide powder 8 subjected to the agitating treatment is diffusion-bonded, i.e. merely physically adhered, to the surface of each iron-carbon alloy powder particle 7 as shown in FIG. 5. Thus, the silicon dioxide powder 8 is apt to come off from the iron-carbon alloy powder particle 7 due to external impacts.

The siliconizing treatment is conducted on a mixture powder of the iron-carbon alloy powder 7 and the silicon dioxide powder 8. Concretely, the mixture powder is put in a furnace having a vacuumable sealed chamber. The furnace is rotated and simultaneously vacuumed. The mixture powder of the iron-carbon alloy powder 7 and the silicon dioxide powder 8 is heated under a predetermined temperature condition. Herein, the predetermined temperature condition is a temperature needed to release silicon element from the silicon dioxide powder 8 and cause the silicon element to penetrate and diffuse into the iron powder particle 2. In this embodiment, for example, the predetermined temperature condition is set at 1180° C. or less. To be more concrete, when a content of carbon element in the iron-carbon alloy powder particle 7 is adjusted in a range from 0.1 to 1.0 weight % and the silicon dioxide is adjusted to at least the content of carbon element or more, the predetermined temperature is preferably controlled in a range from 900° C. or more and 1050° C. or less. In this heat treatment, oxidation-reduction reaction occurs between the silicon dioxide powder 8 and carbon atoms of the iron-carbon alloy powder 7, thereby releasing silicon element from each silicon dioxide powder particle 8 and generating carbon monoxide gas (CO gas). The released silicon element is impregnated into the surface layer of the iron powder particle 2 and diffused into the iron powder particle 2. As the heating time passes, the silicon element is concentrated in the surface layer of the iron powder 2 and form the silicon impregnated layer 3 as shown in FIG. 6. During this siliconizing treatment, the generated carbon monoxide gas is exhausted to the outside of the furnace by vacuuming, thus maintaining the internal pressure of the furnace at a constant level. Such siliconizing treatment is performed under a release/diffusion atmosphere in which the rate of reaction in which the silicon element is generated by release is higher than the rate of impregnation/diffusion of the silicon element into the surface layer of the iron powder 2 so that the thickness of the silicon impregnated layer 3 is adjusted to 0.15 times of a mean (average) particle diameter D of the iron powder 2.

The heating time for heating the iron-carbon alloy powder 7 and the silicon dioxide powder 8 is determined to diffuse and bond the silicon dioxide powder 8 onto the surface of the silicon impregnated layer 3. In this embodiment, if the mean particle diameter of the silicon dioxide powder 8 is 1 μm or less, the heating time is preferably set to 45 minutes or shorter.

After the predetermined heating time passes, a drying treatment is conducted to dry the powder taken out of the furnace. The silicon dioxide powder 8 forms into the diffusion-bonded part 4 including the protruding portion 4b that has not completely been impregnated in the silicon impregnated layer 3 and remains on the surface of the silicon impregnated layer 3 and the diffused portion 4a that has been impregnated and diffused in the silicon impregnated layer 3 and firmly chemically bonded to the silicon impregnated layer 3. Thus, the powder 11 subjected to the siliconizing treatment is produced.

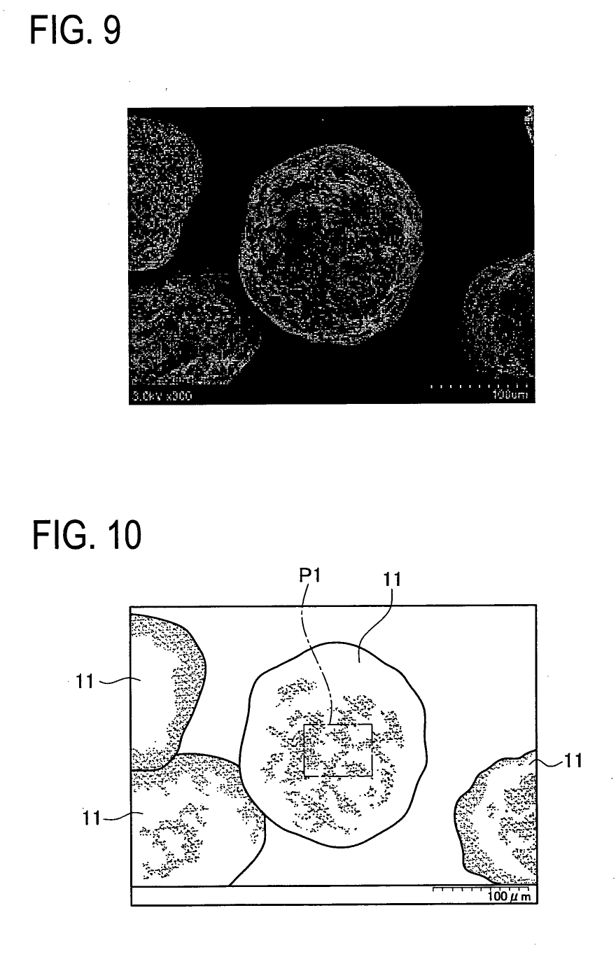

The particle shape of the powder 11 subjected to the siliconizing treatment is explained below referring to FIGS. 9 to 16. FIGS. 9, 11, 13, and 15 are micrographs of the powder 11 subjected to the siliconizing treatment. FIGS. 10, 12, 14, and 16 are diagrams illustrating corresponding micrographs of FIGS. 9, 11, 13, and 15.

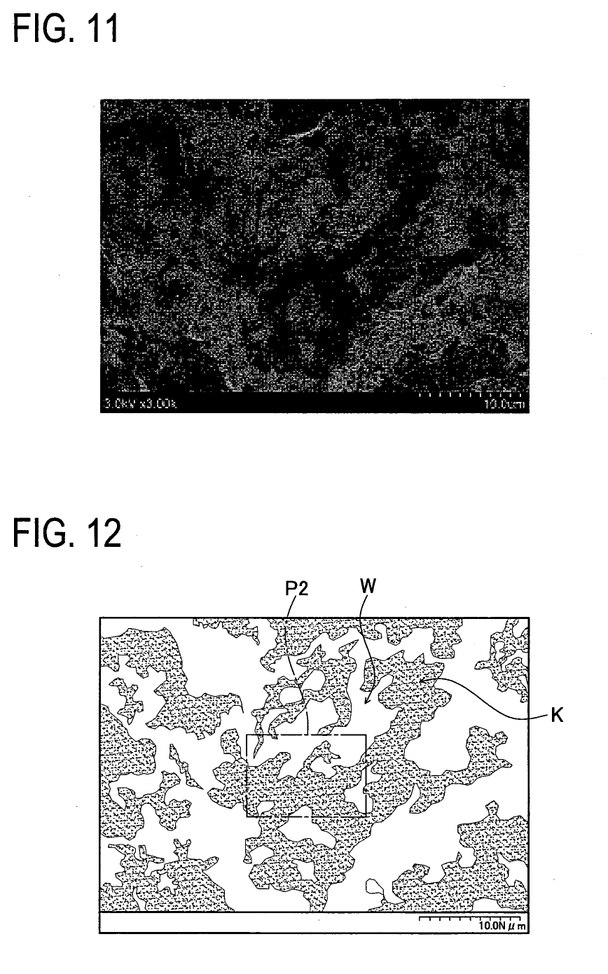

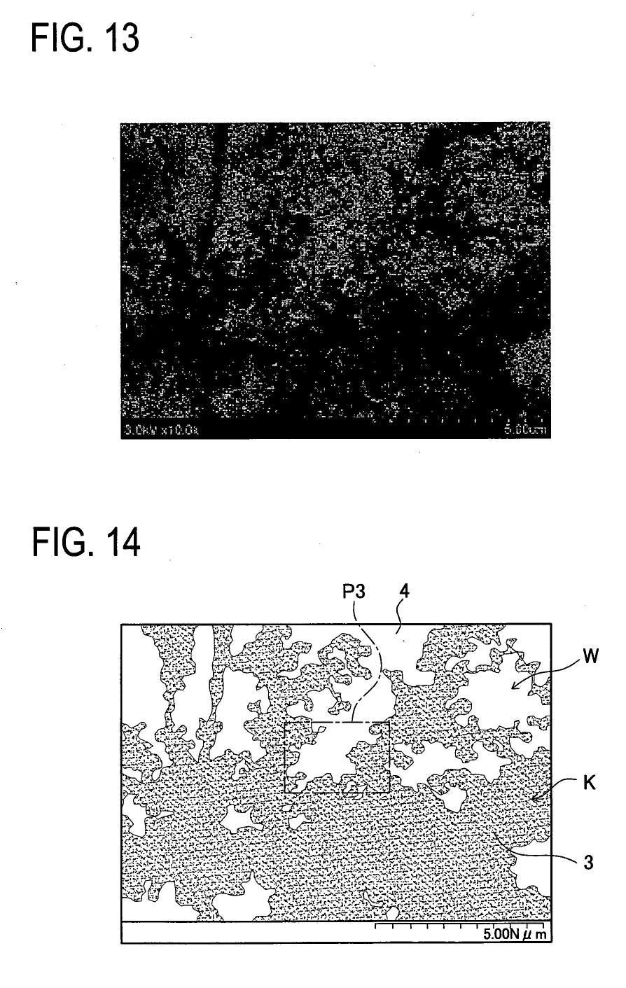

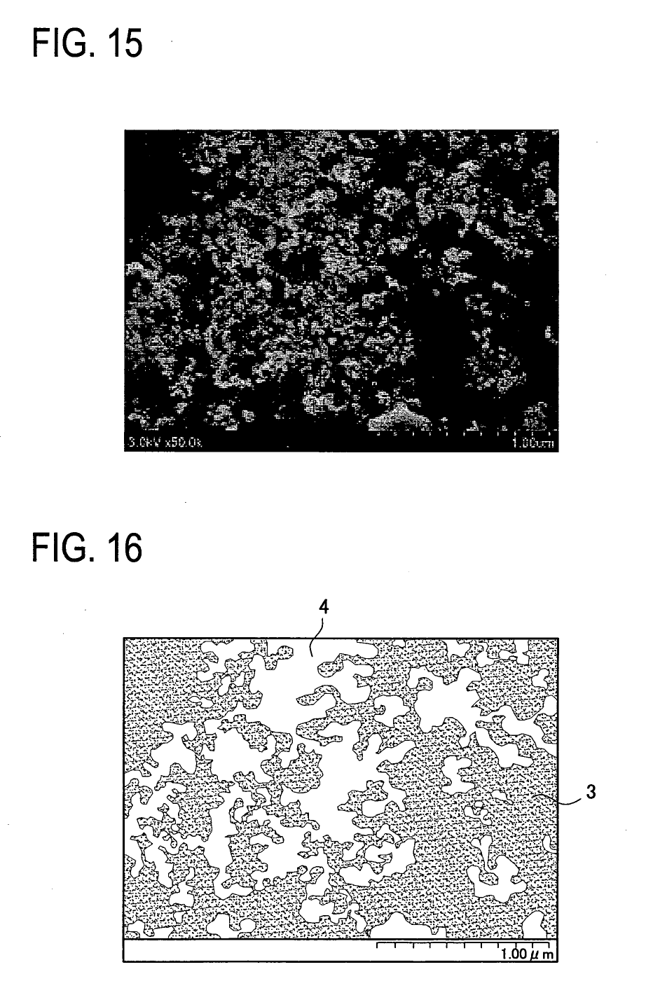

As shown in FIGS. 9 and 10, the micrograph shows some powder particles 11 subjected to the siliconizing treatment. It is seen that the surface of each powder particle 11 is covered with a whitish layer, each outer shape is irregular, and silicon element is diffused in the surface of each iron powder particle 2. When a part of FIG. 9 corresponding to P1 of FIG. 10 is enlarged, as shown in FIGS. 11 and 12, the surface of each powder particle 11 is formed with a pattern including a blackish zone K and a whitish zone W. When a part of FIG. 11 corresponding to P2 of FIG. 12 is further enlarged, as shown in FIGS. 13 and 14, it is seen that the blackish zone K is the silicon impregnated layer 3 and the whitish zone W is the diffusion-bonded part 4 that has not completely been impregnated in the silicon impregnated layer 3. When a part of FIG. 13 corresponding to P3 of FIG. 14 is further enlarged, as shown in FIGS. 15 and 16, it is seen that the diffusion-bonded part 4 protrudes from the surface of the silicon impregnated layer 3, forming irregular protrusions.

The powder particles 11 are subjected to the coating treatment following the siliconizing treatment. In the coating treatment, the powder particles 11 are put in an ethanol solution in which silicone resin is dissolved. This solution mixed with the powder particles 11 is then agitated. After agitation for a predetermined time, the solution is further agitated to evaporate ethanol, thereby causing the silicone resin to adhere to the surface of each powder particle 11. Accordingly, as shown in FIG. 1, the powder 1 for dust core is produced such that the silicon dioxide diffusion-bonded layer 5 is covered with the silicone coating layer 6.

<Production Method of Dust Core>

A method of producing a dust core by compacting the dust core powder 1 produced as above is explained below.

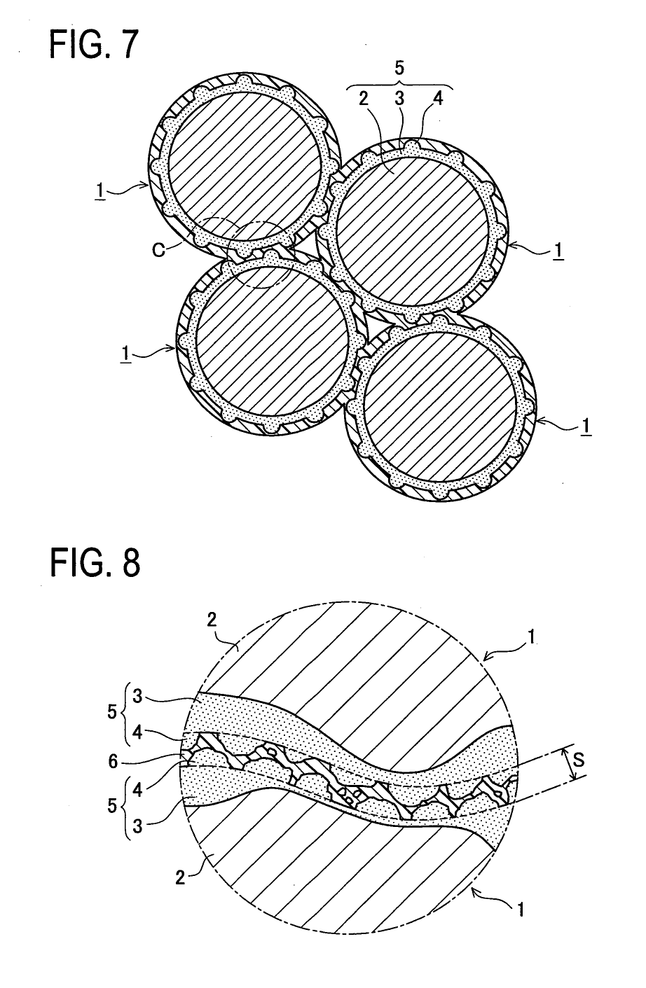

The powder 1 for dust core (“dust core powder”) is filled in a punch die provided with a cavity having a predetermined shape for a motor core and the like. The dust core powder 1 is pressure-formed under a predetermined pressure and heated at a predetermined temperature. The heat during the forming melts the silicone coating layer 6 and forms a layer or film bonding the dust core powder particles 1 to each other as shown in FIG. 7. Herein, during the powder compaction, the powder particles 1 are deformed and thus the resultant thickness of some silicon impregnated layers 3 becomes uneven. In this state, as shown in FIG. 8, the top portion of each diffusion-bonded part 4 protruding from the surface of the silicon impregnated layer 3 of the dust core powder particle 1 presses against the diffusion-bonded part 4 or the silicon impregnated layer 3 of an adjacent dust core powder particle 1, thus generating a gap S between the silicon impregnated layers 3 of adjacent powder particles 1. A pressure-formed product is taken out of the cavity and subjected to a high-temperature annealing treatment to remove the internally caused process strain. Consequently the dust core having a predetermined shape is produced.

### EXAMPLES

Examples of the above embodiment are explained below

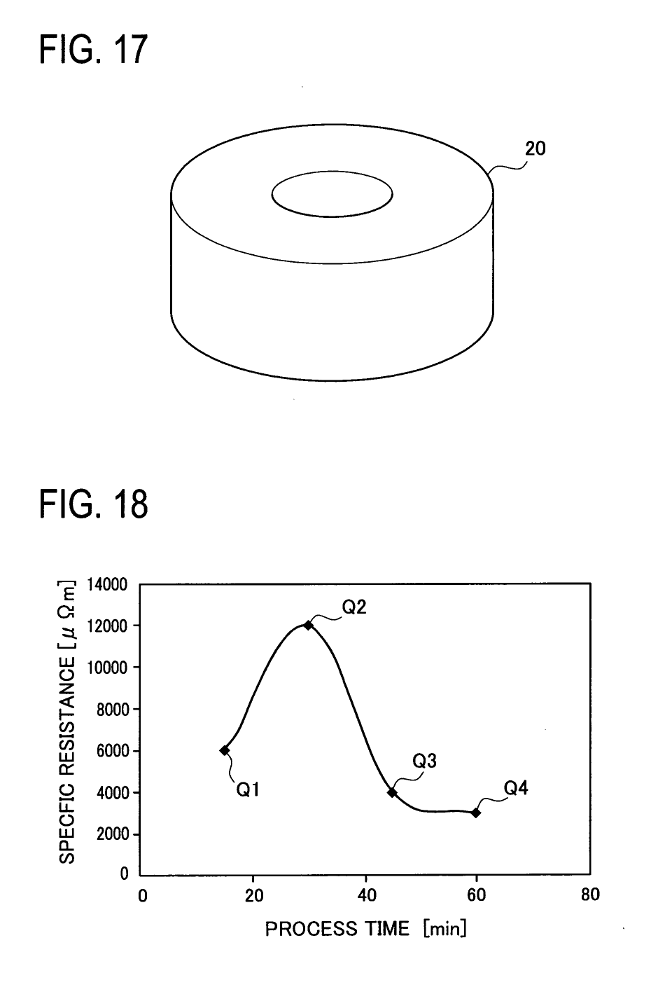

A powder for dust core used in Example 1 is produced in the following manner. An iron powder 2 having a mean particle diameter of 150 μm to 210 μm and a specific gravity of 7.8 and a silicon dioxide powder 8 having a mean particle diameter of 50 nm and a specific gravity of 2.2 are mixed at a ratio of 95 to 97 weight % of the iron powder 2 and 3 to 5 weight % of the silicon dioxide powder 8. This mixture is agitated and then put in the vacuumable furnace. This furnace is vacuumed to 10⁻³ Pa. Successively, the furnace is rotated and the mixture powder is heated at 1100° C. for 15 minutes. This powder is then taken out of the furnace and the surface of each powder particle is coated with the silicone resin. The powder for dust core is completed. The thus produced dust core powder is filled in the cavity of the punching die and powder compaction is conducted under a press pressure of 1600 MPa to produce a ring member 20 (having an outside diameter of 40 mm, an inside diameter of 30 mm, and a thickness of 5 mm) as shown in FIG. 17, which is an example of the dust core. This produced ring member is subjected to a heat treatment at 750° C. for 60 minutes to remove process strain caused during the pressure forming. In Example 1, the pressure-formed product is produced as above.

In Example 2, a pressure-formed product is produced under the same conditions in Example 1 excepting that a heating time for siliconizing in manufacturing a dust core powder is set at 30 minutes.

In Example 3, a pressure-formed product is produced under the same conditions in Example 1 excepting that a heating time for siliconizing in manufacturing a dust core powder is set at 45 minutes.

In Example 4, a pressure-formed product is produced under the same conditions in Example 1 excepting that a heating time for siliconizing in manufacturing a dust core powder is set at 60 minutes.

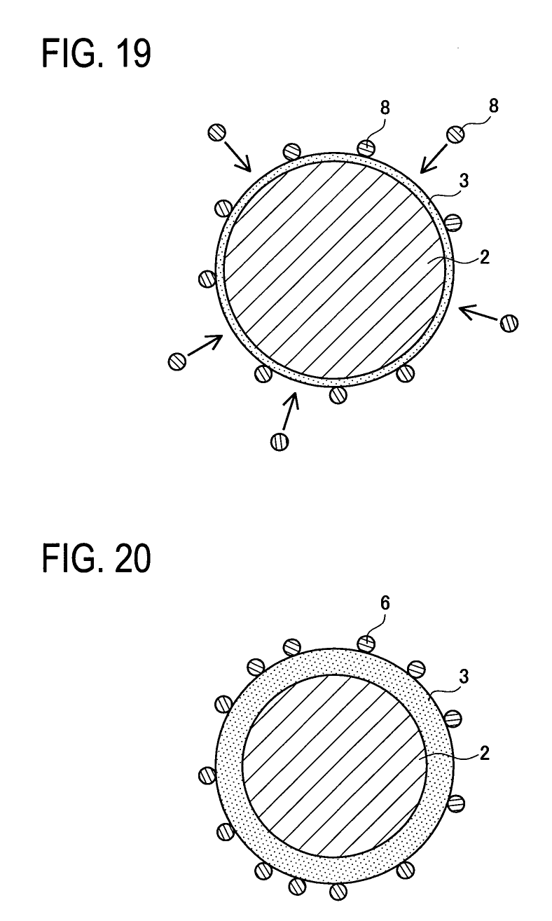

Specific resistances (μΩm) in Examples 1 to 4 were measured. This experimental result is shown in FIG. 18, in which a vertical axis indicates specific resistance (μΩm) and a lateral axis indicates heating time (min.). FIGS. 19 to 21 are conceptual diagrams of a cross section of the dust core powder used in Examples 1, 3, and 4.

As indicated by Q1 in FIG. 18, the specific resistance in Example 1 is 6000 μΩm. As indicated by Q2 in FIG. 18, the specific resistance in Example 2 is 12000 μΩm. As indicated by Q3 in FIG. 18, the specific resistance in Example 3 is 4000 μΩm. As indicated by Q4 in FIG. 18, the specific resistance is 3000 μΩm.

It is found from Q1 and Q2 in FIG. 18 that when the heating time for heating the mixture powder in the siliconizing treatment is in a range from 15 minutes to 30 minutes, the specific resistance increases as the heating time passes.

This is conceivably because, after the start of heat treatment, the silicon element of the silicon dioxide powder particle 8 begin to be gradually diffused and impregnated in each iron powder particle 2 and then concentrated, the insulation property of the powder for dust core is enhanced. In particular, much silicon dioxide powder particles 8 adherable to the iron powder particles 2 exist in the furnace after the start of heat treatment. Accordingly, as soon as the silicon element is released from the silicon dioxide powder particle 8 and diffused and impregnated in the iron powder particle 2, another silicon dioxide powder particle 8 adheres to the surface of the iron powder particle 2 and begins to be diffused and impregnated therein. When the silicon dioxide powder particles 8 consecutively adhere to the iron powder particles 2 as above and the silicon element is diffused and impregnated in the surface layer of each iron powder particle 2, the concentration of the silicon element into the surface layer of each iron powder particle 2 advances, enhancing the insulation property. Thus, it is conceived that the specific resistance increases as the heating time passes.

After the heating time of 30 minutes, the specific resistance becomes maximum.

This results from the following reasons. After the heating time of 30 minutes, the surface area of the iron powder particle 2 occupied by the silicon dioxide powder particles 8 put in the furnace is maximum as shown in FIG. 6. In this state, when the heat treatment is stopped, a part of each silicon dioxide powder particle 8 is impregnated in the silicon impregnated layer 3 and the other part of each silicon dioxide powder particle 8 remains on the surface of the silicon impregnated layer 3. Thus, each silicon dioxide powder particle 8 remains as the diffusion-bonded part 4 on the surface of the silicon impregnated layer 3. Additionally, at that time, the surface area of the iron powder particle 2 occupied by the silicon dioxide powder particles 8 is maximum. Almost the whole surface of the silicon impregnated layer 3 is covered by the diffusion-bonded parts 4. The dust core powder particle 1 subjected to such siliconizing treatment is apt to form the gap S with respect to another dust core powder particle 1 when pressure compacted (for example, see FIG. 8). Accordingly, in the dust core in Example 2, the dust core powder particles 1 have fewer portions where the silicon impregnated layers 3 are likely to contact with each other and hence decrease the insulation property, and the dust core can have a maximum specific resistance.

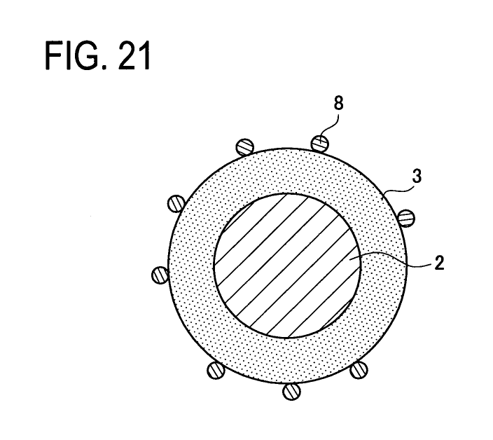

If the heating time exceeds 30 minutes, the specific resistance decreases as the heating time passes. This results from the following reasons. As the heating time advances, the silicon dioxide powder put in the furnace decreases. As shown in FIGS. 20 and 21, the concentration of silicon element advances faster than that new silicon dioxide powder particles 8 adhere to the surface of the iron powder particle 2. If the heat treatment is terminated in such state where the concentration of silicon element has been advanced, the silicon dioxide powder particles 8 are unlikely to remain in a diffusion-bonded state on the surface of the iron powder particle 2. In the dust core powder subjected to such siliconizing treatment, the diffusion-bonded portions of the silicon dioxide powder particles 8 occupy a small surface area of the iron powder particle 2 (a small occupied area by the diffusion-bonded parts 4). Accordingly, when pressure-compacted, the silicon impregnated layer 3 is highly apt to contact with the silicon impregnated layer 3 of another dust core powder particle. The dust core therefore has low insulation property and hence a small specific resistance at the contact portions of the silicon impregnated layers 3. In particular, as the heating time passes, the amount of silicon dioxide powder particles 8 decreases and the concentration of silicon element advances. The specific resistance is therefore decreased according to the heating time.

When the heating time exceeds 50 minutes, the specific resistance becomes almost constant at 3000 μΩm. This is conceivably because the silicon dioxide powder particles 8 disappear in the furnace after a lapse of the heating time of 50 minutes, so that the silicon element is impregnated almost uniformly into the entire iron powder particle 2.

The present inventors studied a relationship between the heating time and the specific resistance by using the silicon dioxide powder particles 8 having different mean particle diameters. It is confirmed from this result that the silicon dioxide powder particles 8 having a mean particle diameter of 1 μm or less could provide the same result as in the above experiment.

From the above experimental result, accordingly, the heating time in the siliconizing treatment is preferably 45 minutes or less for the silicon dioxide powder particles 8 having the mean particle diameter of 1 μm or less.

<Advantages of Diffusion-Bonding of Silicon Dioxide Powder>

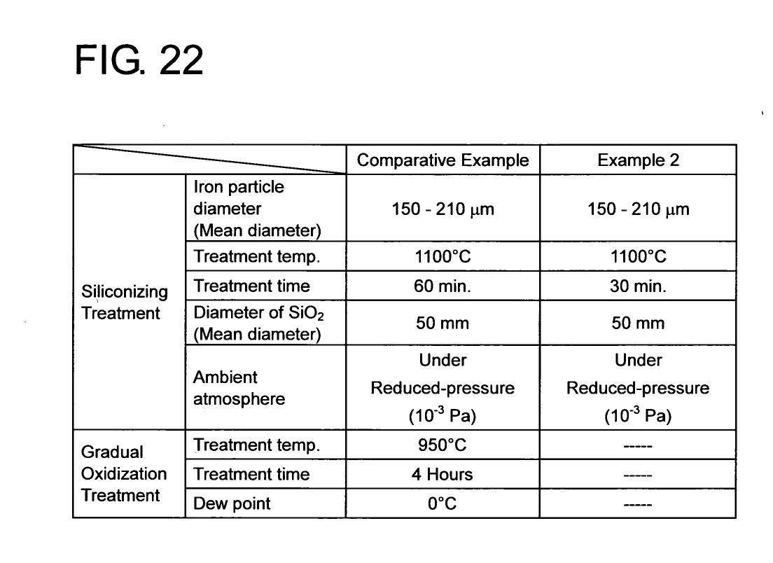

FIG. 22 is a table showing Comparative example and Example 2 to compare respective configurations. The configuration of Example 2 is as mentioned above and its explanation is not repeated here.

On the other hand, a powder for dust core used in Comparative example is subjected to the siliconizing treatment under the condition that the heating time is set at 60 minutes and then the gradual oxidation treatment to form a silicon dioxide containing layer over the silicon impregnated layer. The conditions of the siliconizing treatment in Comparative example are the same as those of the siliconizing treatment in Example 2 excepting the heating time. In the gradual oxidation treatment, the powder already subjected to the siliconizing treatment for a heating time of 60 minutes is put in a H2 gas atmosphere in which a dew point is controlled to 0° C., and the powder is heated at a processing temperature of 950° C. for 4 hours. Accordingly, only the silicon element of the powder is oxidized but the iron powder is not oxidized. After the gradual oxidation treatment, the powder is coated with silicone resin in the same manner as in Example 2. The thus produced powder for dust core is pressure-formed as in Example 2. A sample ring produced as above is used as a Comparative example.

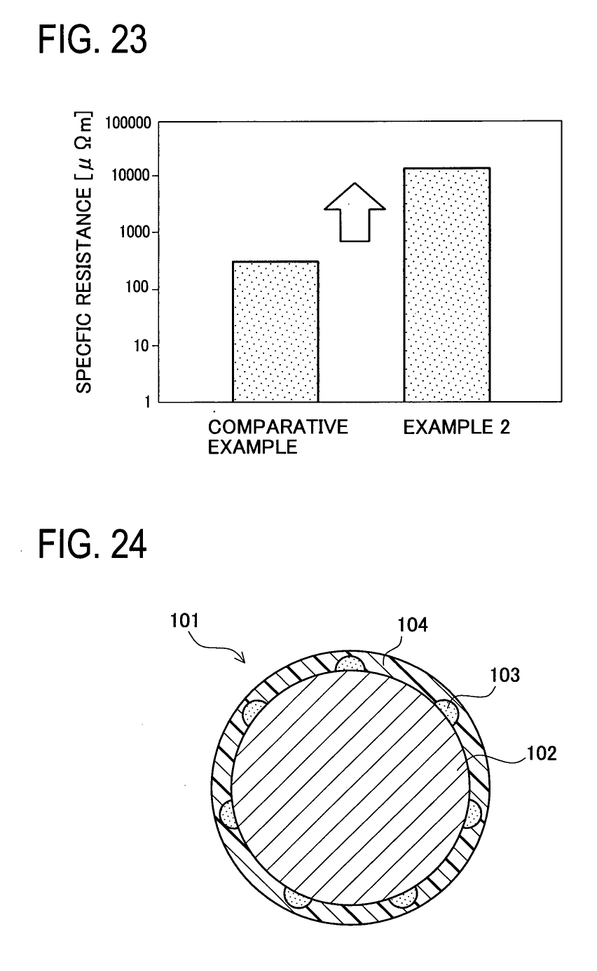

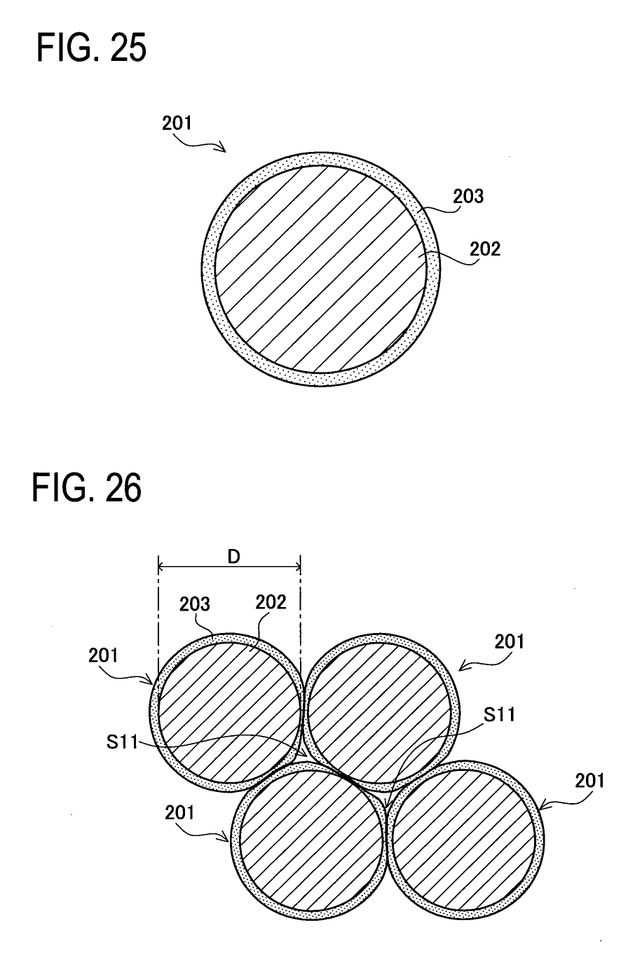

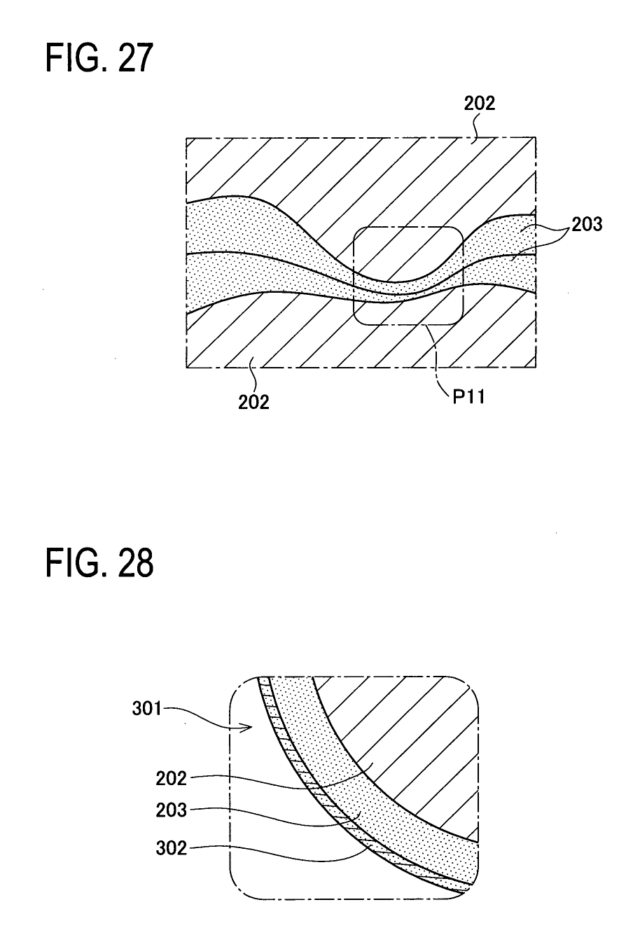

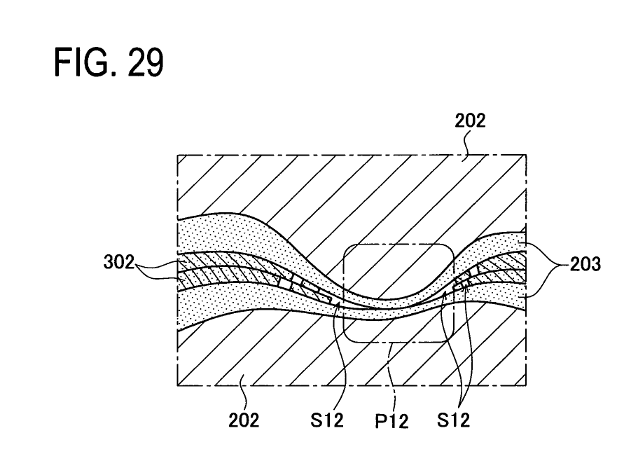

The present inventors measured the specific resistances of Example 2 and Comparative example. This measurement result is shown in FIG. 23.

The specific resistance in Comparative example is 500 μΩm and the specific resistance in Example 2 is 12000 μΩm. Thus, Example 2 could achieve a higher specific resistance 24 times of that in Comparative example. This measurement result proves that the powder in which the silicon dioxide powder 8 is diffusion-bonded to the surface of the silicon impregnated layer 3 could provide a higher specific resistance of the dust core, that is, a smaller iron loss of the dust core as compared with the powder in which the silicon dioxide containing layer is formed over the silicon impregnated layer in the gradual oxidation treatment.

Furthermore, the above experimental result proves that the specific resistance of the dust core could be improved by the siliconizing treatment alone without separately performing the gradual oxidation treatment and the siliconizing treatment. Example 2 is therefore superior to Comparative example in reducing time and labor for the gradual oxidation treatment.

The present invention may be embodied in other specific forms without departing from the spirit or essential characteristics thereof. For instance, the above embodiment exemplifies the iron powder 2 as one example of the soft magnetic metal powder. Other examples of the soft magnetic metal powder are Fe—Si alloy, Fe—Al alloy, Fe—Si—Al alloy, titanium, and aluminum.

For instance, the above embodiment exemplifies the silicon dioxide powder 8 as one example of the powder for siliconizing. Alternative powders for siliconizing may include a mixture powder of a powder containing at least silicon dioxide and a powder containing either or both of metal carbide and carbon allotrope, and a mixture powder of a silicon dioxide containing powder and a silicon carbide powder. In another alternative, an iron powder containing at least oxygen element may be used as the soft magnetic powder and a powder containing at least carbon element may be used as the powder for siliconizing.

In the above embodiment, for example, the siliconizing treatment is conducted under a vacuum atmosphere. Alternatively, the siliconizing treatment may be performed under a reduced-pressure atmosphere, under an ambient atmosphere where gas partial pressure generated is low, concretely, under a low carbon monoxide (CO) atmosphere, or, under a low nitrogen (N₂) atmosphere.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

1 Powder for dust core
2 Iron powder
3 Silicon impregnated layer
6 Silicone coating layer
8 Silicon dioxide powder

1. A powder for dust core, the powder including a soft magnetic metal powder and a silicon impregnated layer made of silicon concentrated in a surface layer of the soft magnetic metal powder,
wherein the silicon impregnated layer includes a silicon dioxide powder diffused and bonded to a surface of the silicon impregnated layer so that a part of the silicon dioxide powder is impregnated and diffused in the silicon impregnated layer and the other part of the silicon dioxide powder protrudes from the surface of the silicon impregnated layer.

2. The powder for dust core according to claim 1, wherein
the silicon dioxide powder is diffused and bonded to the silicon impregnated layer during a siliconizing treatment for forming the silicon impregnated layer.

3. The powder for dust core according to claim 1, wherein the powder for dust core is coated with silicone resin.

4. A dust core made of the powder for dust core set forth in claim 1 by powder compaction.

5. A method of producing a powder for dust core, the method comprising at least a step of performing a siliconizing treatment including:
bringing a powder for siliconizing containing at least a silicon compound into contact with a surface of a soft magnetic metal powder,
heating the powder for siliconizing to release a silicon element from the silicon compound, and
impregnating and diffusing the released silicon element into a surface layer of the soft magnetic metal powder to form a silicon impregnated layer made of silicon concentrated in the surface layer of the soft magnetic metal powder,
wherein the siliconizing treatment includes setting a heating time for heating the powder for siliconizing so that the powder for siliconizing is diffusion-bonded to a surface of the silicon impregnated layer while a part of the powder for siliconizing is impregnated and diffused in the silicon impregnated layer and the other part of the powder for siliconizing protrudes from the surface of the silicon impregnated layer.

6. The method of producing a powder for dust core according to claim 5, further comprising a coating treatment for coating an outer surface of each powder with silicone resin after the powder is subjected to the siliconizing treatment.

7. The method of producing a powder for dust core according to claim 5. wherein
the powder for siliconizing is a silicon dioxide powder, and
the heating time is set at 45 minutes or less when the silicon dioxide powder has a mean particle diameter of 1 μm or less.

8. A dust core made of the powder for dust core by powder compaction, the powder for dust core being produced by the production method of a powder for dust core set forth in claim 5.

9. The powder for dust core according to claim 2, wherein the powder for dust core is coated with silicone resin.

10. A dust core made of the powder for dust core set forth in claim 2 by powder compaction.

11. A dust core made of the powder for dust core set forth in claim 3 by powder compaction.

12. The method of producing a powder for dust core according to claim 6, wherein
the powder for siliconizing is a silicon dioxide powder, and
the heating time is set at 45 minutes or less when the silicon dioxide powder has a mean particle diameter of 1 μm or less.

13. A dust core made of the powder for dust core by powder compaction, the powder for dust core being produced by the production method of a powder for dust core set forth in claim 6.

14. A dust core made of the powder for dust core by powder compaction, the powder for dust core being produced by the production method of a powder for dust core set forth in claim 7.
